(19) United States
(12) Patent Application Publication
(10) Pub. No.: US 2014/0071554 A1
(43) Pub. Date: Mar. 13, 2014

(54) DISPLAY SUBSTRATE AND METHOD OF MANUFACTURING THE SAME

(71) Applicant: Dong Eun LEE, Yongin-City (KR)

(72) Inventor: Dong Eun LEE, Yongin-City (KR)

(21) Appl. No.: 13/948,407

(22) Filed: Jul. 23, 2013

(30) Foreign Application Priority Data
Sep. 11, 2012 (KR) 10-2012-0100595

(51) Int. Cl. B32B 3/26; G02B 5/20

(52) U.S. Cl. CPC B32B 3/266; G02B 5/201
USPC 359/891; 428/138; 427/162

(57) ABSTRACT

A display substrate and a method of forming the same, the display substrate including a substrate; a plurality of organic film patterns on the substrate and physically separated from each other to define an aperture that exposes the substrate; a cell-gap adjustment pattern on the substrate to at least partially overlap the aperture; and an overcoat layer covering the organic film patterns and the cell-gap adjustment pattern, wherein a first height from the substrate to a surface of one portion of the overcoat layer on the cell-gap adjustment pattern is greater than a second height from the substrate to a surface of another portion of the overcoat layer on the organic film patterns, and a difference between a thermal contraction rate of the cell-gap adjustment pattern and a thermal contraction rate of the overcoat layer is 0 to about 10%.

This application claims priority from Korean Patent Application No. 10-2012-0100595 filed on Sep. 11, 2012 in the Korean Intellectual Property Office, the disclosure of which is incorporated herein by reference in its entirety.

### BACKGROUND OF THE INVENTION

1. Field of the Invention

Embodiments relate to a display substrate and a method of manufacturing the same.

2. Description of the Related Art

With the development of display technology, display devices are being widely used in portable devices (such as notebooks, mobile phones and portable media players (PMPs)) as well as display devices for homes (such as TVs and monitors). In particular, the trend toward lighter and thinner display devices is increasing the popularity of liquid crystal displays, organic electroluminescent displays, etc.

### SUMMARY OF THE INVENTION

Embodiments provide a display substrate having improved reliability by preventing the formation of cracks due to a difference in thermal contraction rate.

Embodiments also provide a method of manufacturing a display substrate, the method capable of preventing the formation of cracks due to a difference in thermal contraction rate even in a baking process.

However, the embodiments are not restricted to the one set forth herein. The above and other embodiments will become more apparent to one of ordinary skill in the art to which the embodiments pertains by referencing the detailed description given below.

According to an embodiment, there is provided a display substrate comprising a substrate, a plurality of organic film patterns formed on the substrate and physically separated from each other to define an aperture which exposes the substrate, a cell-gap adjustment pattern formed on the substrate to at least partially overlap the aperture and an overcoat layer covering the organic film patterns and the cell-gap adjustment pattern, wherein a first height from the substrate to a surface of the overcoat layer formed on the cell-gap adjustment pattern is greater than a second height from the substrate to a surface of the overcoat layer formed on the organic film patterns, and a difference between a thermal contraction rate of the cell-gap adjustment pattern and that of the overcoat layer is 0 to 10%.

According to another embodiment, there is provided a display substrate comprising a substrate, a plurality of organic film patterns formed on the substrate and physically separated from each other to define an aperture which exposes the substrate, an overcoat layer covering the organic film patterns and a cell-gap adjustment pattern overlapping the aperture, wherein a height from the substrate to a surface of the cell-gap adjustment pattern is greater than a height from the substrate to a surface of the overcoat layer formed on the organic film patterns, and a difference between a thermal contraction rate of the cell-gap adjustment pattern and that of the overcoat layer is 0 to 10%.

### BRIEF DESCRIPTION OF THE DRAWINGS

The above and other aspects and features will become more apparent by describing in detail exemplary embodiments thereof with reference to the attached drawings, in which:

FIG. 1 illustrates a cross-sectional view of a display substrate according to an embodiment;

FIG. 2 illustrates a cross-sectional view of a display substrate according to another embodiment;

FIG. 3 illustrates a flowchart of a method of manufacturing a display substrate according to an embodiment;

FIGS. 4 through 7 illustrate cross-sectional views of stages in a method of manufacturing the display substrate shown in FIG. 1;

FIGS. 8 through 10 illustrate cross-sectional views of stages in a method of manufacturing the display substrate shown in FIG. 2;

FIG. 11 illustrates a cross-sectional view of a display substrate according to another embodiment;

FIG. 12 illustrates a cross-sectional view of a display substrate according to another embodiment;

FIG. 13 illustrates a flowchart of a method of manufacturing a display substrate according to another embodiment;

FIGS. 14 through 16 illustrate cross-sectional views of stages in a method of manufacturing the display substrate shown in FIG. 11; and

FIGS. 17 through 19 illustrate cross-sectional views of stages in a method of manufacturing the display substrate shown in FIG. 12.

### DETAILED DESCRIPTION OF THE INVENTION

Advantages and features of the embodiments and methods of accomplishing the same may be understood more readily by reference to the following detailed description of preferred embodiments and the accompanying drawings. The embodiments may, however, be implemented in many different forms and should not be construed as being limited to the embodiments set forth herein. Rather, these embodiments are provided so that this disclosure will be thorough and complete and will fully convey the concept of the embodiments to those skilled in the art, and the present invention will only be defined by the appended claims.

It will be understood that when an element or layer is referred to as being “on” another element or layer, it can be directly on the other element or layer or intervening elements or layers may be present. Like numbers refer to like elements throughout.

It will be understood that, although the terms first, second, etc. may be used herein to describe various elements, these elements should not be limited by these terms. These terms are only used to distinguish one element from another element. Thus, for example, a first element, a first component or a first section discussed below could be termed a second element, a second component or a second section without departing from the teachings of the present invention.

Embodiments will now be described with reference to the attached drawings. A case where a display substrate according to the embodiments is applied to a liquid crystal display (LCD) will be described below as an example. However, the embodiments are not limited to this case, and the display substrate according to the embodiments is also applicable to other display devices including an organic light-emitting display (OLED) and a plasma display panel (PDP) without departing from the spirit and scope of the embodiments.

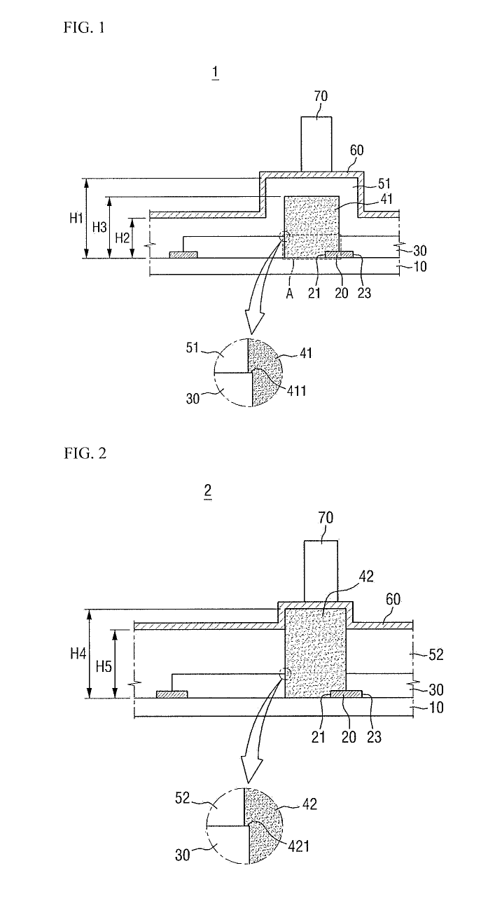

FIG. 1 illustrates a cross-sectional view of a display substrate 1 according to an embodiment.

Referring to FIG. 1, the display substrate 1 may include a substrate 10, a plurality of organic film patterns 30 on the substrate 10, a cell-gap adjustment pattern 41, and an overcoat layer 51. Further, the display substrate 1 may include at least one of a black matrix pattern 20, a thin-film electrode layer 60, and a column spacer 70.

The substrate 10 may include an insulating substrate. The insulating substrate may be made of, e.g., a transparent glass material that contains transparent SiO₂ as its main component. In an implementation, the insulating substrate may be a plastic substrate. In an implementation, the insulating substrate may be a flexible substrate.

The organic film patterns 30 may be formed on the substrate 10. The organic film patterns 30 may be physically separated from each other to define an aperture A that exposes the substrate 10. Each of the organic film patterns 30 may be or include, e.g., a color filter pattern that includes at least one of red (R), green (G), and blue (B). The organic film patterns 30 may be formed by coating an organic film on the substrate 10 and then patterning the organic film using a photolithography process and an etching process that utilize a mask. However, this is merely an example, and the organic film patterns 30 may also be formed using all technologies (such as a deposition method, an inkjet-coating method, and a spraying method) that have been developed and commercialized or which can be realized depending on future technological developments.

If the organic film patterns 30 are composed of or include color filter patterns, the black matrix pattern 20 (that blocks light) may further be formed on the substrate 10. In this case, a side 21 of the black matrix pattern 20 may overlap the aperture A. In addition, another side 23 of the black matrix pattern 20 may overlap each organic film pattern 30. The black matrix pattern 20 may be made of a light-blocking material. Examples of the light-blocking material may include a conductive metal material such as chromium (Cr), molybdenum (Mo), titanium (Ti) or chromium oxide (CrOx), a carbon-based organic material, and a photosensitive resin material.

The cell-gap adjustment pattern 41 may help improve optical characteristics by adjusting a distance by which each of reflected light and transmitted light passes through a liquid crystal layer in a display device. The cell-gap adjustment pattern 41 may be a protruding pattern.

The cell-gap adjustment pattern 41 may be formed on a region of the substrate 10 that is overlapped by the aperture A. The region on which the cell-gap adjustment pattern 41 is formed may correspond to a reflective region of the display device (including the display substrate 1) in which light is reflected. A thickness H3 of the cell-gap adjustment pattern 41 may be greater than a thickness of the organic film patterns 30, such that the overcoat layer 51 may protrude upward to a sufficient extent. The cell-gap adjustment pattern 41 may be made of or include, e.g., thermosetting or photocurable resin having insulating properties. In an implementation, the cell-gap adjustment pattern 41 may be made of or include, e.g., photocurable resin having photosensitivity. The cell-gap adjustment pattern 41 may be formed by coating a cell-gap adjustment pattern material on the organic film patterns 30 and the aperture A formed on the substrate 10 and removing the cell-gap adjustment pattern material from a region that does not overlap the aperture A by patterning the cell-gap adjusting material. In this case, a protrusion 411 of the cell-gap adjustment pattern 41 may be formed on a surface of each organic film pattern 30 as shown in FIG. 1. Although not shown in the drawing, in an implementation, side surfaces of the cell-gap adjustment pattern 41 may be separated from side surfaces of the organic film patterns 30, unlike the illustration in FIG. 1.

The overcoat layer 51 may be formed on the organic film patterns 30 and the cell-gap adjustment pattern 41 to cover the organic film patterns 30 and the cell-gap adjustment pattern 41. A first height H1 from the substrate 10 to a surface of one portion of the overcoat layer 51 (on the cell-gap adjustment pattern 41) may be greater than a second height H2 from the substrate 10 to a surface of another portion of the overcoat layer 51 (on the organic film patterns 30). For example, the first height H1 (that is the sum of the thickness H3 of the cell-gap adjustment pattern 41 and a thickness of the overcoat layer 51 on the cell-gap adjustment pattern 41) may be greater than the second height H2 (that is the sum of the thickness of the organic film patterns 30 and the thickness of the overcoat layer 51 on the organic film patterns 30). Accordingly, a portion of the overcoat layer 51 on the cell-gap adjustment pattern 41 may protrude above the other portion of the overcoat layer 51 on the organic film patterns 30. The first height H1 may be, e.g., 0.8 to 1 times a sum (H2+H3) of the second height H2 and the thickness H3 of the cell-gap adjustment pattern 41.

The overcoat layer 51 may be made of a transparent insulating material such as thermosetting resin or photocurable resin. In an implementation, the overcoat layer 51 may be made of photocurable resin. The overcoat layer 51 may be formed by forming an overcoat film on the organic film patterns 30 and the cell-gap adjustment pattern 41 and patterning the overcoat film such that the first height H1 is greater than the second height H2. However, a method of forming the overcoat layer 51 is not limited to the above method.

A difference between a thermal contraction rate of the cell-gap adjustment pattern 41 and a thermal contraction rate of the overcoat layer 51 may be 0 to about 10%. For example, the material that forms the cell-gap adjustment pattern 41 and the material that forms the overcoat layer 51 may be selected based on a difference value in thermal contraction rate. If the difference between the thermal contraction rate of the cell-gap adjustment pattern 41 and that of the overcoat layer 51 is 0%, it may mean that the cell-gap adjustment pattern 41 and the overcoat layer 51 are made of the same material. For example, if the cell-gap adjustment pattern 41 has a thermal contraction rate of 11% (since its volume contracts to 89% when the cell-gap adjustment pattern 41 is heated from 30 to 200° C.), the overcoat layer 51 may have a thermal contraction rate of 1 to 11% (since its volume contracts to 89 to 99% when the overcoat layer 51 is heated from 30 to 200° C.). Conversely, if the overcoat layer 51 has a thermal contraction rate of 11% when heated from 30 to 200° C., the cell-gap adjustment pattern 41 may have a thermal contraction rate of 1 to 11% when heated from 30 to 200° C. For example, the material that forms the overcoat layer 51 and the material that forms the cell-gap adjustment pattern 41 may be selected based on the difference value in thermal contraction rate. Therefore, even if other elements (such as the thin-film electrode layer 60) are further formed on the overcoat layer 51, the formation of cracks in other elements (such as the thin-film electrode layer 60) during a baking process performed in the process of manufacturing the display substrate 1 may be minimized.

The thin-film electrode layer 60 may be formed on the overcoat layer 51. The thin-film electrode layer 60 may serve as a common electrode of the display device, e.g., may receive a common voltage. The thin-film electrode layer 60 may be made of a transparent conductor, e.g., indium tin oxide (ITO), indium zinc oxide (IZO), tin oxide (TO), or indium tin zinc oxide (ITZO). The thin-film electrode layer 60 may be formed using any suitable method, for example, a sputtering method.

The overcoat layer 51 may cover the cell-gap adjustment pattern 41, and the thin-film electrode layer 60 may formed on the overcoat layer 51. Therefore, a horizontal width of an upwardly protruding portion of the thin-film electrode layer 60 formed on the overcoat layer 51 may be greater than a horizontal width of the aperture A.

The column spacer 70 may be formed on the thin-film electrode layer 60 to maintain a constant gap between the substrate 10 and a counter substrate (not shown). The column spacer 70 may be formed at any suitable position that does not limit a path of light. For example, the column spacer 70 may be formed in a region that overlaps the aperture A or a region that overlaps the black matrix pattern 20, as shown in FIG. 1. The column spacer 70 may be made of or include, e.g., a photocurable or thermosetting material having insulating properties. In an implementation, the column spacer 70 may be made of a photocurable material. Examples of the photocurable material may include benzocyclobutene (BCB), photoacryl, cytop, and perfluorocyclobutene. To form the column spacer 70 of a photocurable material, a photocurable column spacer material may be coated on the thin-film electrode layer 60, and a photolithography process and an etching process may be performed using a mask. Then, remaining column spacer material may be completely cured using a baking process, thereby forming the column spacer 70.

In the baking process performed to form the spacer column 70, the cell-gap adjustment pattern 41 and the overcoat layer 51 may also contract due to heat. Here, if the cell-gap adjustment pattern 41 and the overcoat layer 51 have significantly different thermal contraction rates, cracks may be formed in step portions of the thin-film electrode layer 60. However, according to the current embodiment, the difference between the thermal contraction rate of the cell-gap adjustment pattern 41 and that of the overcoat layer 51 is controlled to 0 to about 10%. Therefore, the formation of cracks in the thin-film electrode layer 60 may be minimized and/or prevented.

FIG. 2 illustrates a cross-sectional view of a display substrate 2 according to another embodiment. The display substrate 2 according to the current embodiment is identical to the display substrate 1 of FIG. 1 except that an overcoat layer buries only part of a cell-gap adjustment pattern and that a thin-film electrode layer are formed on the overcoat layer and exposed surfaces of the cell-gap adjustment pattern, and thus any repetitive description thereof may be omitted.

Referring to FIG. 2, a cell-gap adjustment pattern 42 of the display substrate 2 according to the current embodiment may protrude above a surface of an overcoat layer 52. For example, a top surface of the cell-gap adjustment pattern 42 and side surfaces adjacent to the top surface may be externally exposed from the overcoat layer 52. As shown in FIG. 2, a thin-film electrode layer 60 may be formed on the top surface and the side surfaces. A thickness H4 of the cell-gap adjustment pattern 42 may be greater than a sum H5 of a thickness of organic film patterns 30 and a thickness of the overcoat layer 52 on the organic film patterns 30.

As described above with reference to FIG. 1, the cell-gap adjustment pattern 42 may be formed by coating a cell-gap adjustment pattern material and patterning the cell-gap adjustment pattern material. In this case, a protrusion 421 of the cell-gap adjustment pattern 42 may be formed on a surface of each organic film pattern 30. However, this is merely an example. Although not shown in the drawing, side surfaces of the cell-gap adjustment pattern 42 may be separated from side surfaces of the organic film patterns 30.

The overcoat layer 52 may be formed on the organic film patterns 30 and may be structured to cover only part of the cell-gap adjustment pattern 42. For example, the overcoat layer 52 may not cover the top surface of the cell-gap adjustment pattern 42 and part of each side surface of the cell-gap adjustment pattern 42. Accordingly, the top surface of the cell-gap adjustment pattern 42 and part of each side surface that adjoins the top surface protrude above the overcoat layer 52. The overcoat layer 52 may be made of or may include, e.g., thermosetting resin or photocurable resin. In an implementation, to form the overcoat layer 52 of photocurable resin, an overcoat film may be formed on the organic film patterns 30 and the cell-gap adjustment pattern 42 and then patterned to remove a portion of the overcoat film formed on the cell-gap adjustment pattern 42 and a portion of the overcoat film formed on the organic film patterns 30. As a result, the overcoat layer 52 may be formed. However, a method of forming the overcoat layer 52 is not limited to the above method.

Unlike the illustration in FIG. 1, the thin-film electrode layer 60 may be formed not only on the overcoat layer 52 but also on the exposed surfaces of the cell-gap adjustment pattern 42. Accordingly, as shown in FIG. 2, a horizontal width of the thin-film electrode layer 60 formed on the cell-gap adjustment pattern 42 may be similar to a horizontal width of an aperture A. Other features of the thin-film electrode layer 60 may be identical to those of the thin-film electrode layer 60 described above with reference to FIG. 1, and thus a repetitive description thereof may be omitted.

A column spacer 70 may be formed on the thin-film electrode layer 60 to maintain a constant gap between the substrate 10 and a counter substrate (not shown). The column spacer 70 may be formed at any suitable position that does not limit the path of light. For example, the column spacer 70 may be formed in a region that overlaps the aperture A or a region that overlaps a black matrix pattern 20, as shown in FIG. 2.

In a baking process performed to form the spacer column 70, the cell-gap adjustment pattern 42 and the overcoat layer 52 may also contract due to heat. Here, if the cell-gap adjustment pattern 42 and the overcoat layer 52 were to have significantly different thermal contraction rates, cracks may be formed in step portions of the thin-film electrode layer 60. However, according to the current embodiment, a difference between a thermal contraction rate of the cell-gap adjustment pattern 42 and that of the overcoat layer 52 is controlled to 0 to about 10%. Therefore, the formation of cracks in the thin-film electrode layer 60 may be minimized and/or prevented. All other features are identical to those described above with reference to FIG. 1, and thus a repetitive description thereof may be omitted.

FIG. 3 illustrates a flowchart of a method of manufacturing a display substrate according to an embodiment. For example, FIG. 3 is a schematic flowchart illustrating a method of manufacturing the display substrates 1 and 2 shown in FIGS. 1 and 2.

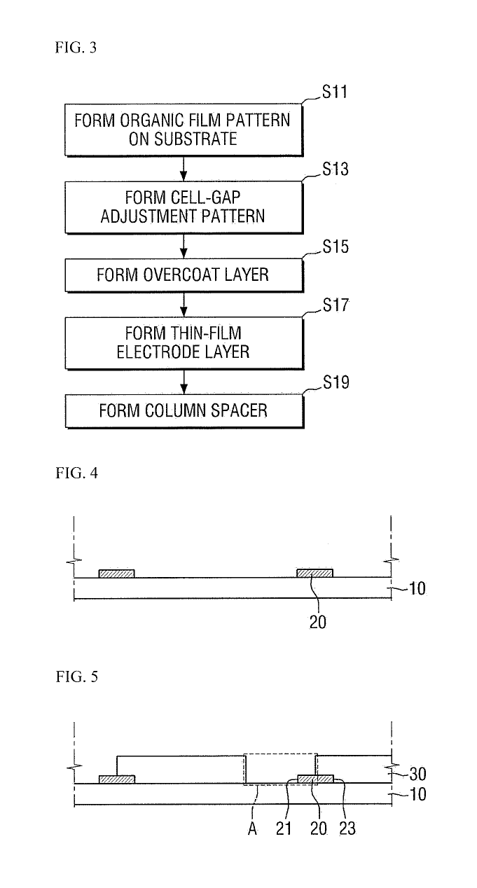

Referring to FIG. 3, the method of manufacturing a display substrate according to the current embodiment may include forming a plurality of organic film patterns on a substrate (operation S11), wherein the organic film patterns are physically separated from each other to define an aperture which exposes the substrate. After the organic film patterns are formed, a cell-gap adjustment pattern may be formed in the aperture on the substrate (operation S13), and then an overcoat layer may be formed (operation S15). The manufacturing method may further include forming a thin-film electrode layer (operation S17) after operation S15 and forming a column spacer on the thin-film electrode layer (operation S19). Although not shown in the drawing, when desired, an operation of patterning the thin-film electrode layer may further be performed between operation S17 and operation S19. Alternatively, the operation of patterning the thin-film electrode layer may be performed after operation S19. In addition, an operation of forming a black matrix pattern on the substrate may further be formed before operation S11. A more detailed description will be given below with reference to FIGS. 4 through 7 and 8 through 10.

FIGS. 4 through 7 illustrate cross-sectional views of stages in a method of manufacturing the display substrate 1 shown in FIG. 1.

Referring to FIGS. 1 and 3 through 7, a light-blocking material may be coated on a substrate 10. Then, the light-blocking material may be patterned by a photolithography process and an etching process using a mask. As a result, a plurality of black matrix patterns 20 (which are separated from each other) may be formed as shown in FIG. 4. Examples of the light-blocking material may include a conductive metal material such as chromium (Cr), molybdenum (Mo), titanium (Ti) or chromium oxide (CrOx), a carbon-based organic material, and a photosensitive resin material.

Next, an organic film may be coated on the substrate 10 and then patterned by a photolithography process and an etching process using a mask. As a result, a plurality of organic film patterns 30 may be formed as shown in FIG. 5. However, this is merely an example, and the organic film patterns 30 may also be formed using various methods such as an inkjet-printing method, a spraying method, a coating method, and a deposition method. The organic film patterns 30 may be physically separated from each other to define an aperture A that exposes the substrate 10. The aperture A may overlap a side 21 of each black matrix pattern 20. If the organic film patterns 30 are composed of color filter patterns, a region of each organic film pattern 30 may overlap another side 23 of a corresponding black matrix pattern 20.

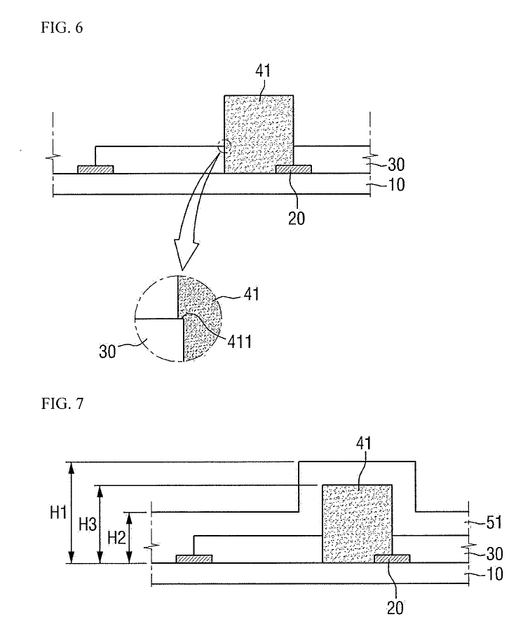

After the organic film patterns 30 are formed, a cell-gap adjustment pattern material may be coated on the organic film patterns 30 and the aperture A to cover the organic film patterns 30 and fill the aperture A. Then, the cell-gap adjusting material may be removed by a photolithography process and an etching process, except a portion which overlaps the aperture A. As a result, a cell-gap adjustment pattern 41 may be formed as shown in FIG. 6. After the cell-gap adjusting material is removed, a baking process may be further be performed. In this case, a protrusion 411 of the cell-gap adjustment pattern 41 may be formed on a surface of each organic film pattern 30 due to a difference in the removal of the cell-gap adjustment pattern material. Also, side surfaces of the cell-gap adjustment pattern 41 may be separated from side surfaces of the organic film patterns 30 as described above with reference to FIG. 1.

The cell-gap adjustment pattern material may be made of a material whose thermal contraction rate is different from that of an overcoat layer (which will be formed later) by 0 to about 10%. For example, the cell-gap adjustment pattern material and the overcoat layer may be selected based on a difference value in thermal contraction rate. If a difference between a thermal contraction rate of the cell-gap adjustment pattern material and that of the overcoat layer is 0%, it may mean that the cell-gap adjustment pattern material and the overcoat layer are made of the same material. Other features may be identical to those described above with reference to FIG. 1, and thus a repetitive description thereof may be omitted.

The cell-gap adjustment pattern 41 may be formed thicker than the organic film patterns 30 by controlling a thickness to which the cell-gap adjusting material is coated.

After the cell-gap adjustment pattern 41 is formed, an overcoat film may be coated to cover the organic film patterns 30 and the cell-gap adjustment pattern 41. Then, an overcoat layer 51 may be formed as shown in FIG. 7 by adjusting a thickness of the overcoat film using a photography process and an etching process. After the overcoat film is etched, a baking process may further be performed. Here, the overcoat layer 51 may be formed such that a first height H1 (from the substrate 10 to a surface of the overcoat layer 51 formed on the cell-gap adjustment pattern 41) is greater than a second height H2 (from the substrate 10 to a surface of the overcoat layer 51 formed on the organic film patterns 30). The overcoat layer 51 may be made of a material whose thermal contraction rate is different from that of the cell-gap adjustment pattern material by 0 to about 10% as described above with reference to FIG. 1.

After the overcoat layer 51 is formed, a thin-film electrode layer material may be deposited on the overcoat layer 51, thereby forming a thin-film electrode layer 60 (see FIG. 1). Therefore, a horizontal width of an upwardly protruding portion of the thin-film electrode layer 60 formed on the overcoat layer 51 may be greater than a horizontal width of the aperture A. The thin-film electrode material may include any one of ITO, IZO, TO, and ITZO. In an implementation, the thin-film electrode layer material may be deposited by, e.g., sputtering.

After the thin-film electrode layer 60 (see FIG. 1) is formed, a column spacer material may be coated on the thin-film electrode layer 60 (see FIG. 1) and then removed using a photolithography process and an etching process, except a portion which overlaps the aperture A. Next, a baking process may be performed to completely cure the column spacer material remaining on the thin-film electrode layer 60 (see FIG. 1). As a result, a column spacer 70 (see FIG. 1) may be formed.

In the process of completely curing the column spacer material, the cell-gap adjustment pattern 41 and the overcoat layer 51 may contract due to heat. According to the current embodiment, the difference between the thermal contraction rate of the cell-gap adjustment pattern 41 and that of the overcoat layer 51 may be 0 to about 10%. Therefore, even if the cell-gap adjustment pattern 41 and the overcoat layer 51 contract, the formation of cracks in the thin-film electrode layer 60 may be minimized and/or prevented. Other features may be identical to those described above with reference to FIG. 1, and thus a repetitive description thereof may be omitted.

Although not shown in the drawing, after the thin-film electrode layer 60 (see FIG. 1) may be formed, it may be patterned. For example, the thin-film electrode layer 60 (see FIG. 1) may be patterned after the thin-film electrode layer 60 (see FIG. 1) is formed and before the column spacer 70 (see FIG. 1) is formed. Alternatively, the thin-film electrode layer 60 (see FIG. 1) may be patterned after the column spacer 70 (see FIG. 1) is formed.

In the manufacturing method according to the current embodiment, even when a baking process is performed to form the column spacer 70 (see FIG. 1), the formation of cracks in the thin-film electrode layer 60 (due to the difference in thermal contraction between the cell-gap adjustment pattern 41 and the overcoat layer 51) may be reduced and/or prevented. Accordingly, this may help reduce product defect rate and may facilitate the provision of a display substrate with improved reliability.

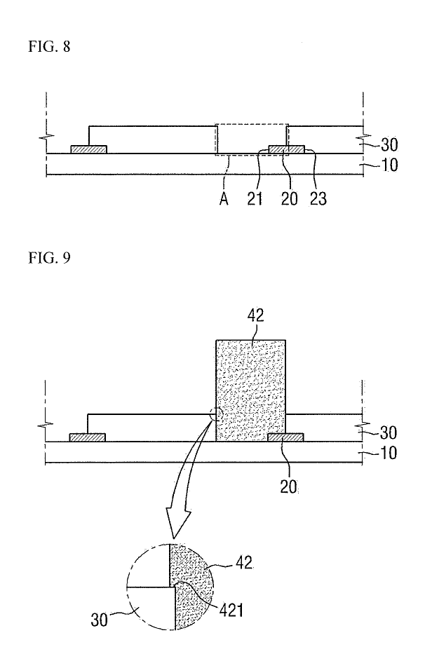

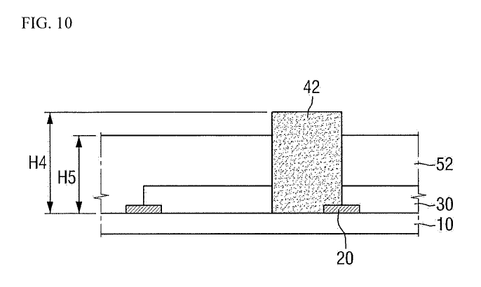

FIGS. 8 through 10 illustrate cross-sectional views of stages in a method of manufacturing the display substrate 2 shown in FIG. 2.

Referring to FIGS. 2 through 10, a plurality of black matrix patterns 20 may be formed on a substrate 10 and then a plurality of organic film patterns 30 may be formed as shown in FIG. 8. The black matrix patterns 20 and the organic film patterns 30 may be identical to those described above with reference to FIGS. 4 and 5, and thus a repetitive description thereof may be omitted.

Next, a cell-gap adjustment pattern material may be coated on the organic film patterns 30 and an aperture A to cover the organic film patterns 30 and the aperture A and then removed using a photolithography process and an etching process, except a portion which overlaps the aperture A. As a result, a cell-gap adjustment pattern 42 may be formed as shown in FIG. 9. The cell-gap adjustment pattern 42 may be formed thicker than the organic film patterns 30. A protrusion 421 of the cell-gap adjustment pattern 42 may be formed on a surface of each organic film pattern 30. Alternatively, side surfaces of the cell-gap adjustment pattern 41 may be separated from side surfaces of the organic film patterns 30. Other features may be identical to those described above with reference to FIG. 1, and thus a repetitive description thereof may be omitted.

After the cell-gap adjustment pattern 42 is formed, an overcoat film may be coated on the organic film patterns 30 and the cell-gap adjustment pattern 42. Then, an overcoat layer 52 may be formed as shown in FIG. 10 by adjusting a thickness of the overcoat film using a photography process and an etching process. Here, the cell-gap adjustment pattern 42 may protrude above a surface of the overcoat layer 52, and a sum H5 of a thickness of the organic film patterns 30 and a thickness of the overcoat layer 52 may be smaller than a thickness of the cell-gap adjustment pattern 42. The overcoat layer 52 may be made of or include a material whose thermal contraction rate is different from that of the cell-gap adjustment pattern material by 0 to about 10% as described above with reference to FIGS. 1 through 7.

After the overcoat layer 52 is formed, a thin-film electrode layer material may be deposited on the overcoat layer 52 and exposed surfaces of the cell-gap adjustment pattern 42, thereby forming a thin-film electrode layer 60 (see FIG. 2). The thin-film electrode layer material may be deposited also on the exposed surfaces of the cell-gap adjustment pattern 42. Thus, a horizontal width of a portion of the thin-film electrode layer 60 which is formed on the exposed surfaces of the cell-gap adjustment pattern 42 may be similar to a horizontal width of the aperture A. Other features of the thin-film electrode layer 60 (see FIG. 2) may be identical to those of the thin-film electrode layer 60 described above with reference to FIGS. 1, 2 and 7, and thus a repetitive description thereof may be omitted.

A column spacer material may be coated on the thin-film electrode layer 60 (see FIG. 2), and then a column spacer 70 (see FIG. 2) may be formed using a photolithography process, an etching process, and a baking process. In the baking process, the cell-gap adjustment pattern 42 and the overcoat layer 52 may contract due to heat. According to the current embodiment, a difference between a thermal contraction rate of the cell-gap adjustment pattern 42 and that of the overcoat layer 52 may be 0 to about 10%. Therefore, even if the cell-gap adjustment pattern 42 and the overcoat layer 52 contract, the formation of cracks in the thin-film electrode layer 60 (see FIG. 2) may be minimized and/or prevented. Other features may be identical to those described above with reference to FIGS. 1 through 7, and thus a repetitive description thereof may be omitted.

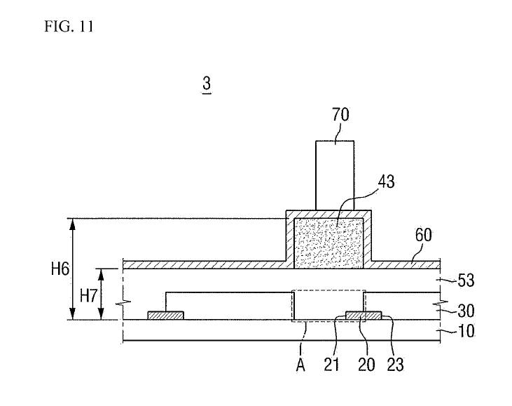

FIG. 11 illustrates a cross-sectional view of a display substrate 3 according to another embodiment.

The display substrate 3 according to the current embodiment may be identical to the display substrate 2 of FIG. 2 except the structure of an overcoat layer and the structure of a cell-gap adjustment pattern, and thus any repetitive description thereof may be omitted.

Referring to FIGS. 1, 2 and 11, an overcoat layer 53 of the display substrate 3 according to the current embodiment may not only cover organic film patterns 30 but also fill an aperture A formed on a substrate 10. For example, the overcoat layer 53 may cover the organic film patterns 30 and the aperture A. The overcoat layer 53 may be formed by forming an overcoat film on the substrate 10 and the organic film patterns 30 and then curing the overcoat film. However, a method of forming the overcoat layer 53 is not limited to the above method. Other features of the overcoat layer 53 may be identical to those of the overcoat layer 51 (see FIG. 1) described above with reference to FIG. 1, and thus a repetitive description thereof may be omitted.

A cell-gap adjustment pattern 43 (that overlaps the aperture A) may be formed on the overcoat layer 53. The cell-gap adjustment pattern 43 may be formed using various suitable methods. For example, the cell-gap adjustment pattern 43 may be formed by coating a cell-gap adjustment pattern material on the overcoat layer 53 and removing the cell-gap adjustment pattern material from a region that does not overlap the aperture A by patterning the cell-gap adjustment pattern material. Alternatively, the cell-gap adjustment pattern 43 formed in advance may be attached onto the overcoat layer 53. Alternatively, when the overcoat layer 53 is formed, the cell-gap adjustment pattern 43 may be formed by forming a protrusion only in a region which overlaps the aperture A using a photolithography process and an etching process. In this case, the cell-gap adjustment pattern 43 and the overcoat layer 53 may be integrated with each other.

A difference between a thermal contraction rate of the cell-gap adjustment pattern 43 and that of the overcoat layer 53 may be 0 to about 10%. For example, the material that forms the cell-gap adjustment pattern 43 and the material that forms the overcoat layer 53 may be selected based on a difference value in thermal contraction rate as described above with reference to FIGS. 1 and 2.

A thin-film electrode layer 60 may be formed on exposed surfaces of the cell-gap adjustment pattern 43 and the overcoat layer 53. For example, both side surfaces and a top surface of the cell-gap adjustment pattern 43 may all be in contact with the thin-film electrode layer 60. A horizontal width of a portion of the thin-film electrode layer 60 (that is formed on the top surface of the cell-gap adjustment pattern 43) may be similar to a horizontal width of the aperture A.

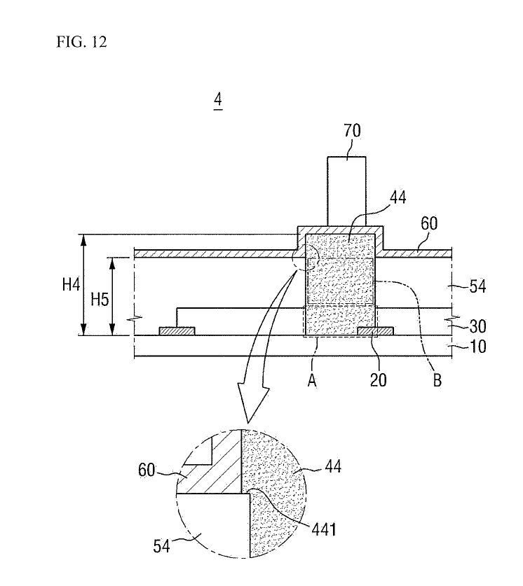

FIG. 12 illustrates a cross-sectional view of a display substrate 4 according to another embodiment.

The display substrate 4 according to the current embodiment may be identical to the display substrate 2 of FIG. 2 except the structure of a cell-gap adjustment pattern formed using a different method, and thus any repetitive description thereof may be omitted.

Referring to FIGS. 1, 2 and 12, an overcoat layer 54 of the display substrate 4 according to the current embodiment may be formed on organic film patterns 30 and may be divided by an aperture A. Accordingly, a space B may be formed in a region that overlaps the aperture A. The overcoat layer 54 may be formed by forming an overcoat film on a substrate 10 and the organic film patterns 30 and removing the overcoat film from the region which overlaps the aperture A using a photolithography process and an etching process. Alternatively, the overcoat layer 54 may be formed by coating an overcoat film on the organic film patterns 30 and a whole surface of the substrate 10 and physically removing a portion of the overcoat film which overlaps the aperture A. However, a method of forming the overcoat layer 54 is not limited to the above methods.

A cell-gap adjustment pattern 44 may be formed on the aperture A on the substrate 10 to overlap the aperture A. The cell-gap adjustment pattern 44 may extend from the substrate 10, on which the aperture A is formed, through the space B to above a surface of the overcoat layer 54. For example, a thickness of the cell-gap adjustment pattern 44 may be greater than a sum of a thickness of the organic film patterns 30 and a thickness of the overcoat layer 54. The cell-gap adjustment pattern 44 may be formed using various suitable methods. For example, the cell-gap adjustment pattern 44 may be formed by forming a cell-gap adjustment pattern material on the overcoat layer 54 to cover the overcoat layer 54 and fill the aperture A and the space B and removing the cell-gap adjustment pattern material from a region that does not overlap the aperture A by patterning the cell-gap adjustment pattern material. Alternatively, the cell-gap adjustment pattern 44 formed in advance may be inserted into the aperture A and the space B to be attached onto the substrate 10. If the cell-gap adjustment pattern 44 is formed by coating and patterning a cell-gap adjustment pattern material, a protrusion 441 of the cell-gap adjustment pattern 44 may be formed on the surface of the overcoat layer 54. However, the embodiments are not limited thereto, and side surfaces of the cell-gap adjustment pattern 44 may also be separated from side surfaces of the overcoat layer 54.

A difference between a thermal contraction rate of the cell-gap adjustment pattern 44 and that of the overcoat layer 54 may be 0 to about 10%. For example, the material that forms the cell-gap adjustment pattern 44 and the material that forms the overcoat layer 54 may be selected based on a difference value in thermal contraction rate as described above with reference to FIGS. 1 and 2.

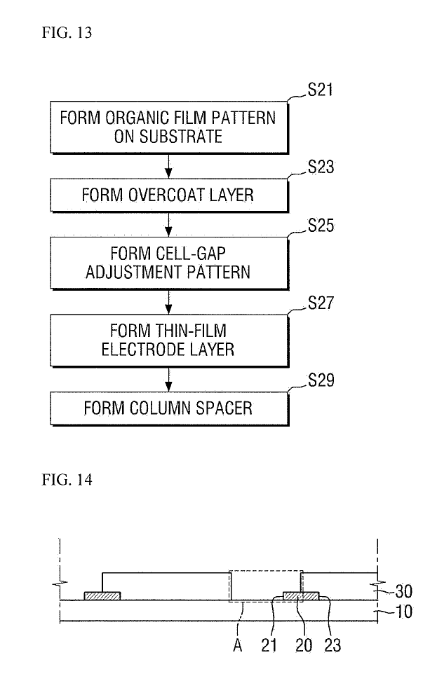

FIG. 13 illustrates a flowchart of a method of manufacturing a display substrate according to another embodiment. For example, FIG. 13 is a schematic flowchart illustrating a method of manufacturing the display substrates 3 and 4 shown in FIGS. 11 and 12.

Referring to FIG. 13, the method of manufacturing a display substrate according to the current embodiment may include forming a plurality of organic film patterns on a substrate (operation S21), wherein the organic film patterns are physically separated from each other to define an aperture which exposes the substrate. After the organic film patterns are formed, an overcoat layer may be formed on the substrate (operation S23), and then a cell-gap adjustment pattern may be formed (operation S25). The manufacturing method may further include forming a thin-film electrode layer (operation S27) after operation S25 and forming a column spacer on the thin-film electrode layer (operation S29). Although not shown in the drawing, when desired, an operation of patterning the thin-film electrode layer may further be performed between operation S27 and operation S29. Alternatively, the operation of patterning the thin-film electrode layer may be performed after operation S29. In addition, an operation of forming a black matrix pattern on the substrate may further be formed before operation S21. A more detailed description will be given below with reference to FIGS. 14 through 16 and 17 through 19.

FIGS. 14 through 16 illustrate cross-sectional views of stages in a method of manufacturing the display substrate 3 shown in FIG. 11. Referring to FIGS. 4 through 16, a plurality of black matrix patterns 20 may be formed on a substrate 10 and then a plurality of organic film patterns 30 may be formed as shown in FIG. 14. The black matrix patterns 20 and the organic film patterns 30 may be identical to those described above with reference to FIGS. 4 and 5, and thus a repetitive description thereof may be omitted.

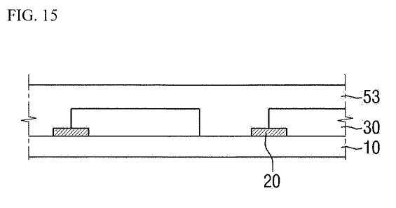

After the organic film patterns 30 are formed, an overcoat film may be coated on the substrate 10 to cover the organic film patterns 30 and fill an aperture A. As a result, an overcoat layer 53 may be formed as shown in FIG. 15. Here, a photocuring process or a thermal curing process may further be performed depending on characteristics of the material that forms the overcoat layer 53.

After the overcoat layer 53 is formed, a cell-gap adjustment pattern 43 may be formed as shown in FIG. 16 on a portion of the overcoat layer 53 that overlaps the aperture A. Here, the overcoat layer 43 may be formed by coating a cell-gap adjustment pattern material on the overcoat layer 53 and then patterning the cell-gap adjustment pattern material. Alternatively, the cell-gap adjustment pattern 43 formed in advance may be attached onto the overcoat layer 53. Alternatively, when the overcoat layer 53 is formed, the cell-gap adjustment pattern 43 may also be formed by forming a protrusion only in a region which overlaps the aperture A using a photolithography process and an etching process, as described above with reference to FIG. 11.

After the cell-gap adjustment pattern 43 is formed, a thin-film electrode layer 60 (see FIG. 11) may be formed on the overcoat layer 53 and exposed surfaces of the cell-gap adjustment pattern 43. Other features of the thin-film electrode layer 60 may be identical to those of the thin-film electrode layer 60 described above with reference to FIGS. 4 through 7, and thus a repetitive description thereof may be omitted.

After the thin-film electrode layer 60 (see FIG. 11) is formed, a column spacer 70 (see FIG. 11) may be further formed on the thin-film electrode layer 60 (see FIG. 11, thereby completing the display substrate 3 structured as shown in FIG. 11. In a baking process performed to form the spacer column 70, the cell-gap adjustment pattern 43 and the overcoat layer 53 may also contract due to heat. According to the current embodiment, a difference between a thermal contraction rate of the cell-gap adjustment pattern 43 and that of the overcoat layer 53 may be 0 to about 10%. Therefore, even if the cell-gap adjustment pattern 43 and the overcoat layer 53 contract, the formation of cracks in the thin-film electrode layer 60 (see FIG. 11) may be minimized and/or prevented. All other features may be identical to those described above with reference to FIGS. 1 through 7, and thus a repetitive description thereof may be omitted.

In the manufacturing method according to the current embodiment, the formation of cracks in the thin-film electrode layer 60 (see FIG. 11) in the process of manufacturing the display substrate 3 may be reduced and/or prevented. Thus, the product defect rate may be reduced, and a display substrate with improved reliability may be provided.

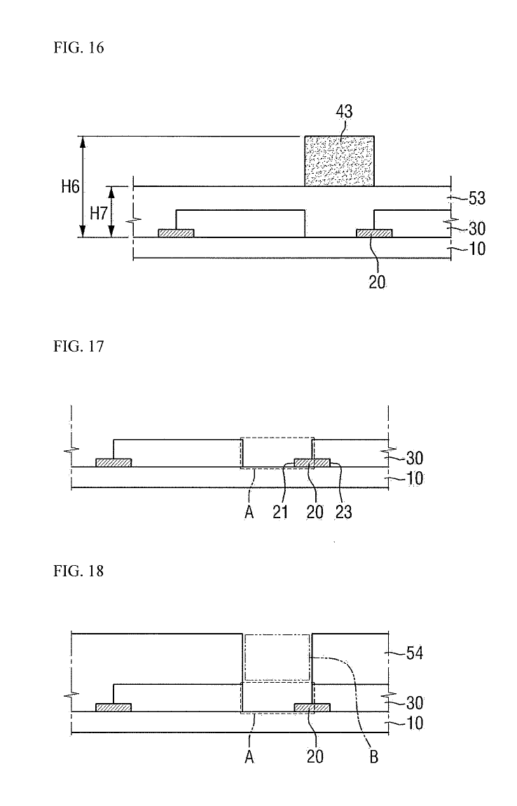

FIGS. 17 through 19 illustrate cross-sectional views of stages in a method of manufacturing the display substrate 4 shown in FIG. 12.

Referring to FIGS. 4 through 19, a plurality of black matrix patterns 20 may be formed on a substrate 10 and then a plurality of organic film patterns 30 may be formed as shown in FIG. 17. The black matrix patterns 20 and the organic film patterns 30 may be identical to those described above with reference to FIGS. 4 and 5, and thus a repetitive description thereof may be omitted.

After the organic film patterns 30 are formed, an overcoat film may be coated on the substrate 10 to fill an aperture A and cover the organic film patterns 30. Then, the overcoat film may be removed from a region which overlaps the aperture A using a photolithography process and an etching process. As a result, an overcoat layer 54 and a space B may be formed as shown in FIG. 18. Alternatively, the overcoat layer 54 and the space B may be formed by coating an overcoat film on the organic film patterns 30 and a whole surface of the substrate 10 and physically removing a portion of the overcoat film which overlaps the aperture A. However, a method of forming the overcoat layer 54 and the space B is not limited to the above methods.

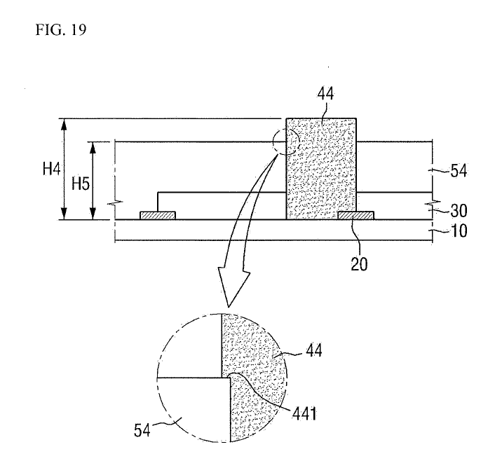

After the overcoat layer 54 is formed, a cell-gap adjustment pattern 44 may be formed to extend from the substrate 10, on which the aperture A is formed, through the space B to above a surface of the overcoat layer 54, as shown in FIG. 19. The cell-gap adjustment pattern 44 may be formed as follows. A cell-gap adjustment pattern material may be coated on the overcoat layer 54 to cover the overcoat layer 54 and fill the aperture A and the space B. Then, the cell-gap adjustment pattern material may be removed from a region that does not overlap the aperture A by patterning the cell-gap adjustment pattern material using a photolithography process and an etching process. As a result, the cell-gap adjustment pattern 44 may be formed. Alternatively, the cell-gap adjustment pattern 44 formed in advance may be inserted into the aperture A and the space B to be attached onto the substrate 10. The cell-gap adjustment pattern 44 may also be formed using various other methods as described above with reference to FIG. 12. If the cell-gap adjustment pattern 44 is formed by coating and patterning a cell-gap adjustment pattern material, a protrusion 441 of the cell-gap adjustment pattern 44 may be formed on the surface of the overcoat layer 54. However, the embodiments are not limited thereto as described above.

After the cell-gap adjustment pattern 44 is formed, a thin-film electrode layer 60 (see FIG. 12) may be further formed on the overcoat layer 54 and exposed surfaces of the cell-gap adjustment pattern 44, and a column spacer 70 (see FIG. 12) may be further formed, thereby completing the display substrate 4 structured as shown in FIG. 12. The thin-film electrode layer 60 and the column spacer 70 may be identical to those described above with reference to FIGS. 2 and 8 through 10, and thus a repetitive description thereof may be omitted.

Until now, a case where a display substrate according to the embodiments includes a black matrix pattern, a thin-film electrode layer, and a column spacer has been described as an example. However, this is merely an example, and at least one of the above elements may be omitted.

By way of summation and review, a display device may include a thin-film transistor substrate and a color filter substrate. The color filter substrate may include an overcoat layer on a base substrate, a cell-gap pattern (that improves optical characteristics by adjusting a cell gap between the thin-film transistor substrate and the color filter substrate), a common electrode on the above elements, and a column spacer (that maintains a constant gap between the thin-film transistor substrate and the color filter substrate).

When the color filter substrate is manufactured, a baking process may be performed to form the column spacer. In the baking process, the overcoat layer and the cell-gap pattern may contract due to heat, and cracks may be formed in the common electrode on the overcoat layer and the cell-gap pattern due to a difference between thermal contraction rates of the overcoat layer and the cell-gap pattern.

In contrast, embodiments provide at least one of the following advantages. For example, cracks may be prevented from being formed in a thin-film electrode layer in the process of manufacturing a display substrate. Therefore, the product defect rate may be reduced.

As noted above, the formation of cracks may be prevented. Thus, a display substrate having improved reliability may be provided. However, the effects of the embodiments are not restricted to the one set forth herein. The above and other effects of the present invention will become more apparent to one of daily skill in the art to which the present invention pertains by referencing the claims.

While the present invention has been particularly shown and described with reference to exemplary embodiments thereof, it will be understood by those of ordinary skill in the art that various changes in form and details may be made therein without departing from the spirit and scope of the present invention as defined by the following claims. It is therefore desired that the present embodiments be considered in all respects as illustrative and not restrictive, reference being made to the appended claims rather than the foregoing description to indicate the scope of the invention.

What is claimed is:

1. A display substrate, comprising:
a substrate;
a plurality of organic film patterns on the substrate and physically separated from each other to define an aperture that exposes the substrate;
a cell-gap adjustment pattern on the substrate to at least partially overlap the aperture; and
an overcoat layer covering the organic film patterns and the cell-gap adjustment pattern,
wherein:
a first height from the substrate to a surface of one portion of the overcoat layer on the cell-gap adjustment pattern is greater than a second height from the substrate to a surface of another portion of the overcoat layer on the organic film patterns, and
a difference between a thermal contraction rate of the cell-gap adjustment pattern and a thermal contraction rate of the overcoat layer is 0 to about 10%.

2. The display substrate of claim 1, wherein the first height is 0.8 to 1 times a sum of the second height and a thickness of the cell-gap adjustment pattern.

3. The display substrate of claim 1, wherein the cell-gap adjustment pattern includes a protrusion on a surface of each of the organic film patterns.

4. The display substrate of claim 1, further comprising a black matrix pattern on the substrate and having a side which overlaps the aperture, wherein the organic film patterns include color filter patterns.

5. The display substrate of claim 1, further comprising:
a thin-film electrode layer on the overcoat layer; and
a column spacer on the thin-film electrode layer.

6. A display substrate, comprising:
a substrate;
a plurality of organic film patterns on the substrate and physically separated from each other to define an aperture that exposes the substrate;
an overcoat layer covering the organic film patterns; and
a cell-gap adjustment pattern overlapping the aperture,
wherein:
a height from the substrate to a surface of the cell-gap adjustment pattern is greater than a height from the substrate to a surface of the overcoat layer on the organic film patterns, and
a difference between a thermal contraction rate of the cell-gap adjustment pattern and a thermal contraction rate of the overcoat layer is 0 to about 10%.

7. The display substrate of claim 6, wherein the cell-gap adjustment pattern includes a protrusion on a surface of each of the organic film patterns.

8. The display substrate of claim 6, wherein:
the overcoat layer covers the aperture, and
the cell-gap adjustment pattern is on the overcoat layer.

9. The display substrate of claim 6, wherein:
the overcoat layer is divided by the aperture to form a space, and
the cell-gap adjustment pattern extends from the aperture on the substrate through the space to above the surface of the overcoat layer.

10. The display substrate of claim 9, wherein the cell-gap adjustment pattern includes a protrusion on the surface of the overcoat layer.

11. The display substrate of claim 6, further comprising a black matrix pattern on the substrate and having a side that overlaps the aperture, wherein the organic film patterns include color filter patterns.

12. The display substrate of claim 6, further comprising:
a thin-film electrode layer on the overcoat layer; and
a column spacer on the thin-film electrode layer.

13. A method of manufacturing a display substrate, the method comprising:
forming a plurality of organic film patterns on a substrate to define an aperture that exposes the substrate;
forming a cell-gap adjustment pattern on the substrate to at least partially overlap the aperture; and
forming an overcoat layer that covers the organic film patterns and the cell-gap adjustment pattern,
wherein a difference between a thermal contraction rate of the cell-gap adjustment pattern and a thermal contraction rate of the overcoat layer is 0 to about 10%.

14. The method of claim 13, wherein forming the overcoat layer includes coating an overcoat film on the organic film patterns and the cell-gap adjustment pattern and forming the overcoat layer such that a first height from the substrate to a surface of one portion of the overcoat layer on the cell-gap adjustment pattern is greater than a second height from the substrate to a surface of another portion of the overcoat layer on the organic film patterns.

15. The method of claim 14, wherein the first height is 0.8 to 1 times a sum of the second height and a thickness of the cell-gap adjustment pattern.

16. The method of claim 13, wherein forming the overcoat layer includes:
coating an overcoat film on the organic film patterns and the cell-gap adjustment pattern; and
patterning the overcoat film such that the cell-gap adjustment pattern protrudes above a surface of the overcoat film.

17. The method of claim 13, further comprising, after forming the overcoat layer:
forming a thin-film electrode layer on the overcoat layer; and
forming a column spacer on the thin-film electrode layer to overlap the cell-gap adjustment pattern.

18. The method of claim 13, further comprising forming a black matrix pattern on the substrate before the forming of the organic film patterns such that the black matrix pattern has a side overlapping the aperture, wherein the organic film patterns include color filter patterns.

19. A method of manufacturing a display substrate, the method comprising:
forming a plurality of organic film patterns on a substrate to define an aperture that exposes the substrate;
forming an overcoat layer on the substrate such that the overcoat layer covers the organic film patterns and the aperture; and
forming a cell-gap adjustment pattern on the overcoat layer to overlap the aperture,
wherein a height from the substrate to a surface of the cell-gap adjustment pattern is greater than a height from the substrate to a surface of the overcoat layer on the organic film patterns, and a difference between a thermal contraction rate of the cell-gap adjustment pattern and a thermal contraction rate of the overcoat layer is 0 to about 10%.

20. The method of claim 19, further comprising, after forming the cell-gap adjustment pattern:
forming a thin-film electrode layer on the overcoat layer and the cell-gap adjustment pattern; and
forming a column spacer on the thin-film electrode layer to overlap the cell-gap adjustment pattern.

21. The method of claim 20, further comprising forming a black matrix pattern on the substrate before the forming of the organic film patterns such that the black matrix pattern has a side overlapping the aperture, wherein the organic film patterns include color filter patterns.

22. A method of manufacturing a display substrate, the method comprising:
forming a plurality of organic film patterns on a substrate to define an aperture that exposes the substrate;
forming an overcoat layer on the substrate such that the overcoat layer covers the organic film patterns and a region excluding the aperture; and
forming a cell-gap adjustment pattern that extends from the aperture on the substrate to above a surface of the overcoat layer,
wherein a difference between a thermal contraction rate of the cell-gap adjustment pattern and a thermal contraction rate of the overcoat layer is 0 to about 10%.

23. The method of claim 22, wherein forming the overcoat layer includes:
forming an overcoat film on the organic film patterns and the aperture; and
forming a space by removing a portion of the overcoat film on the aperture.

24. The method of claim 23, wherein forming the cell-gap adjustment pattern includes:
coating a cell-gap adjustment pattern material on the overcoat layer to fill the aperture and the space; and
removing a portion of the cell-gap adjustment pattern material that does not overlap the aperture.

25. The method of claim 22, further comprising, after forming the cell-gap adjustment pattern:
forming a thin-film electrode layer on the overcoat layer and the cell-gap adjustment pattern; and
forming a column spacer on the thin-film electrode layer to overlap the cell-gap adjustment pattern.

26. The method of claim 22, further comprising forming a black matrix pattern on the substrate before the forming of the organic film patterns such that the black matrix pattern has a side overlapping the aperture, wherein the organic film patterns include color filter patterns.
